(19) United States
(12) Patent Application Publication
(10) Pub. No.: US 2010/0124382 A1
(43) Pub. Date: May 20, 2010

(54) DISPLAY APPARATUS AND METHOD THEREOF

(75) Inventor: Hyung-jin Choi, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/507,491

(22) Filed: Jul. 22, 2009

(30) Foreign Application Priority Data
Nov. 19, 2008 (KR) 10-2008-115261

(51) Int. Cl. G06K 9/42

(52) U.S. Cl. 382/256

(57) ABSTRACT

A display apparatus and a displaying method thereof are provided. The display apparatus includes image quality improvement unit which performs image quality improvement with respect to video signals, a display unit which displays general video signals and video signals of which image quality is improved by the image quality improvement unit, and a control unit which controls the display unit to move a boundary between a first area on which the general video signals are displayed and a second area on which the video signals of improved image quality are displayed in a specific pattern. Accordingly, the boundary between the first area to which image quality improvement is not applied and the second area to which image quality improvement is applied is movable so that the display apparatus can stimulate the customer's buying interests.

### CROSS-REFERENCE TO RELATED APPLICATIONS

This application claims priority from Korean Patent Application No. 10-2008-115261, filed on Nov. 19, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to a display apparatus and a displaying method thereof, and more particularly, to a display apparatus which is capable of moving an area to which image quality improvement is applied a demo mode and a displaying method thereof.

2. Description of the Related Art

With the development of electronic technology, in particular, of semiconductor technology, many manufacturers of display apparatuses have invested time and money in improving image quality of the display apparatus such as a television.

As well as the technical improvement in the image quality of the display apparatus, a marketing strategy to stimulate customer's buying interests by showing a high quality image to the customers has been performed.

For example, a demo screen is displayed on a department store to show how image quality has been improved. A conventional demo screen is divided into a left screen on which a normal image, to which image quality improvement is not applied, is displayed and a right screen on which a high quality image, to which image quality improvement is applied, is displayed.

However, the conventional method to display the demo screen as described above is insufficient to stimulate the customer's buying interests.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide a display apparatus which is capable of moving a boundary between a first area to which image quality improvement is not applied and a second area to which image quality improvement is applied, and a displaying method thereof.

Consistent with an aspect of the present invention, a display apparatus comprises an image quality improvement unit which performs image quality improvement with respect to video signals, a display unit which displays general video signals and video signals of which image quality is improved by the image quality improvement unit, and a control unit which controls the display unit to move a boundary between a first area on which the general video signals are displayed and a second area on which the video signals of improved image quality are displayed in a specific pattern.

The display apparatus may further comprise a signal generation unit which generates a process enable signal to instruct whether to apply the video signal of improved image quality to each pixel on a screen, and transmits the process enable signal to the display unit.

The boundary may move periodically according to a specific pattern.

If the boundary moves in one direction according to a specific pattern, the boundary may move again in the direction opposite to the one direction.

The display apparatus may further comprise a user interface (UI) unit which provides a UI window to determine a moving direction of the boundary or a moving speed of the boundary.

The specific pattern may be at least one of a pattern in which the boundary moves in a horizontal direction on a display screen of the display unit, a pattern in which the boundary moves in a vertical direction on the display screen, a pattern in which the boundary moves from a specific point on the display screen to a point opposite the specific point, and a pattern in which the boundary rotates from a specific point on the display screen with a predetermined angle.

The display apparatus may further comprise an input unit which receives a command to switch a general screen mode and a demo screen mode in which the general video signals and the video signals of improved image quality coexist.

The input unit may receive a command to switch a movable demo screen mode in which the first area and the second area are displayed with the movable boundary and a still demo screen mode in which the first area and the second area are fixedly displayed.

Consistent with another aspect of the present invention, a displaying method of a display apparatus, comprises performing image quality improvement with respect to video signals, displaying general video signals and video signals of which image quality is improved on a display unit, and moving a boundary between a first area on which the general video signals are displayed and a second area on which the video signals of improved image quality are displayed in a specific pattern.

The displaying method may further comprise generating a process enable signal to instruct whether to apply the video signal of improved image quality to each pixel on a screen, and transmitting the process enable signal to the display unit.

The boundary may move periodically according to a specific pattern.

If the boundary moves in one direction according to a specific pattern, the boundary may move again in the direction opposite to the one direction.

The displaying method may further comprise providing a UI window to determine a moving direction of the boundary or a moving speed of the boundary.

The specific pattern may be at least one of a pattern in which the boundary moves in a horizontal direction on a display screen of the display unit, a pattern in which the boundary moves in a vertical direction on the display screen, a pattern in which the boundary moves from a specific point on the display screen to a point opposite the specific point, and a pattern in which the boundary rotates from a specific point on the display screen with a predetermined angle.

The displaying method may further comprise receiving a command to switch a general screen mode and a demo screen mode in which the general video signals and the video signals of improved image quality coexist.

The receiving operation may receive a command to switch a movable demo screen mode in which the first area and the second area are displayed with the movable boundary and a still demo screen mode in which the first area and the second area are fixedly displayed.

Additional and/or other aspects of the invention will be set forth in part in the description which follows and, in part, will be obvious from the description, or may be learned by practice of the invention.

### BRIEF DESCRIPTION OF THE DRAWING FIGURES

The above and/or other aspects of the present invention will be more apparent by describing certain exemplary embodiments of the present invention with reference to the accompanying drawings, in which:

FIG. 1 is a block diagram illustrating a display apparatus consistent with an exemplary embodiment of the present invention;

FIG. 2 is a view to explain a method for moving an area to which image quality improvement is applied on the display apparatus consistent with an exemplary embodiment of the present invention;

FIG. 3 is a block diagram illustrating the display apparatus of FIG. 1 in detail;

FIGS. 4A to 4C are views illustrating an example of a display pattern in which an area of high quality image moves in a horizontal direction;

FIGS. 5A to 5C are views illustrating an examples of a display pattern in which an area of high quality image moves in a vertical direction;

FIGS. 6A and 6B are views illustrating another examples of a display pattern in which an area of high quality image moves in a vertical direction;

FIGS. 7A to 7D are views illustrating various display patterns of the display apparatus consistent with an exemplary embodiment of the present invention;

FIGS. 8A to 8C are views illustrating various patterns of the display apparatus consistent with an exemplary embodiment of the present invention;

FIG. 9 is a flowchart illustrating a displaying method of the display apparatus consistent with an exemplary embodiment of the present invention; and

FIG. 10 is a flowchart illustrating the displaying method of FIG. 9 in detail.

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

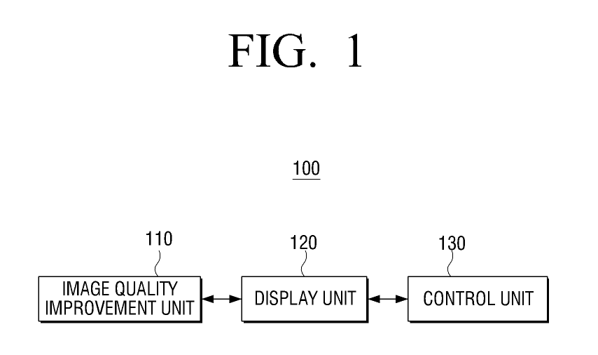

FIG. 1 is a block diagram illustrating a display apparatus consistent with an exemplary embodiment of the present invention. Referring to FIG. 1, a display apparatus 100 comprises an image quality improvement unit 110, a display unit 120, and a control unit 130. The display apparatus 100 consistent with an exemplary embodiment of the present invention may display a general image transmitted from a broadcasting station or may display a demo image.

The image quality improvement unit 110 performs image quality improvement on the video signals. Various operations of improving image quality such as detail enhancement (DE), contrast enhancement (CE), and interlaced to progressive conversion (IPC) may be performed.

The display unit 120 displays general video signals and video signals in which image quality has been improved by the image quality improvement unit 110. The general video signals refer to video signals to which image quality improvement is not applied.

The control unit 130 controls the display unit 120 to move a boundary between a first area on which general video signals are displayed and a second area on which video signals of improved image quality are displayed, in a specific pattern, i.e., in a specific motion.

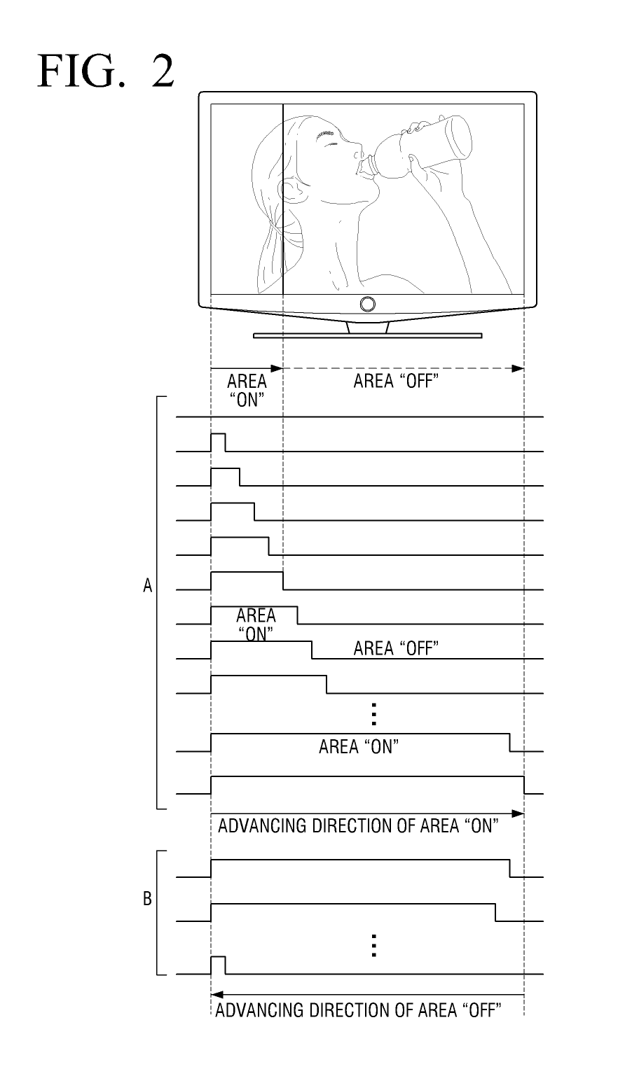

The boundary refers to a contact area between the first area and the second area, for example, a line between the first area and the second area. In the case that the boundary moves in a horizontal direction as shown in FIG. 2, if the boundary moves from the left to the right to the maximum and only the second area is temporarily displayed, the boundary is the rightmost vertical line of the display screen. On the other hand, if the boundary moves from the right to the left to the maximum and only the first area is temporarily displayed, the boundary is the leftmost vertical line of the display screen.

FIG. 2 is a view to explain a method for moving an area to which image quality improvement is applied on the display apparatus consistent with an exemplary embodiment of the present invention.

FIG. 2 illustrates an example of a display pattern in which the first area to which image quality improvement is not applied and the second area to which image quality improvement is applied move in a horizontal direction. In FIG. 2, the area “ON” indicates the second area to which image quality improvement is applied and a signal “1” is applied, whereas the area “OFF” indicates the first area to which image quality improvement is not applied and a signal “0” is applied.

In FIG. 2, the boundary between the first area and the second area on the display screen is expressed by a vertical line. That is, the boundary between the first area and the second area is formed by combining the nth pixels of all horizontal lines (‘n’ is positive integer).

The display screen consists of a plurality of horizontal lines, each of which consists of a plurality of pixels. The plurality of horizontal lines are combined to form a single frame (scene). Also, a signal may be individually applied to each of the plurality of pixels on the display screen to improve image quality.

Referring to the portion “A”, the area to which image quality improvement is applied is enlarged in the right direction. At first, image quality improvement is applied to the first pixel of each horizontal line on the left, and after a predetermined time passes, image quality improvement is applied to the first pixel and the second pixel of each line on the left. Through such a process, the image quality improvement is applied to the entire screen with the boundary moving from the left to the right. After that, as in the portion “B”, the image quality improvement is applied in the opposite direction, i.e., from the right to the left. That is, the boundary between the first area to which the image quality improvement is not applied and the second area to which the image quality improvement is applied moves at predetermined time intervals so that the user can visually check whether image quality improvement has been applied or not.

The boundary between the first area on which general video signals are displayed and the second area on which video signals of improved image quality are displayed may periodically move according to a specific pattern. For example, in FIG. 2, the boundary moves in a horizontal direction in a manner so that that the image quality improvement is applied from the left to the right on the display screen and then returns to the left from the right. That is, the boundary between the first area and the second area moves in one direction according to a specific pattern and then moves in the opposite direction. Such a repetitive operation makes it possible for the customer to distinguish the first area in which image quality improvement is not applied and the second area in which image quality improvement is applied, thereby stimulating the customer's buying interests.

Alternatively, after the image quality enhancement is applied to the entire display screen as the boundary moves from the left to the right as in the area “A”, the entire screen may be instantaneously changed to a state in which image quality improvement is not applied. The process of instantaneously changing the second area to the state in which the image quality improvement is not applied after the image quality improvement is applied from the left to the right is periodically repeated. That is, the boundary between the first area and the second area moves periodically according to a specific pattern.

The specific pattern, that is, various display patterns, will be described with reference to the drawings below.

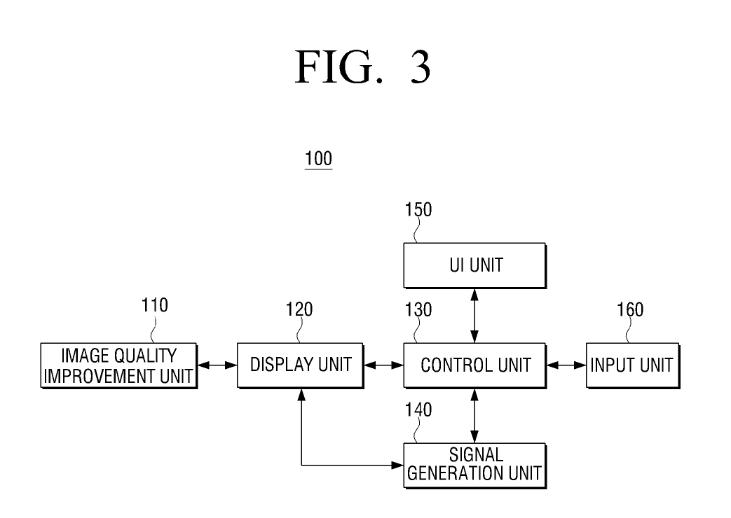

FIG. 3 is a block diagram illustrating the display apparatus of FIG. 1 in detail. Referring to FIG. 3, the display apparatus 100 further comprises a signal generation unit 140, a UI unit 150, and an input unit 160 in addition to the image quality improvement unit 110, the display unit 120 and the control unit 130.

The signal generation unit 140 generates a process enable signal to instruct whether to apply a video signal of improved image quality to each pixel on the display screen, and transmits the process enable signal to the display unit 120. More specifically, the signal generation unit 140 applies the process enable signal to each pixel of the display unit 120, thereby providing the video signal of the improved image quality to each pixel. The process enable signal may be individually applied to each pixel.

The UI unit 150 may provide a UI window to determine a moving direction of the boundary or a moving speed of the boundary. The UI unit 150 may be realized as an on screen demand (OSD) screen of the display apparatus 100 or may be realized as a pop-up window in the case of a digital TV.

For example, through the UI window of the UI unit 150, the boundary may be set to move from the left to the right or from the right to the left.

Also, for example, the image quality improvement may be applied from the left to the right in the unit of one pixel, two pixels, three pixels, and so on, every one second through the UI window of the UI unit 150. Alternatively, the image quality improvement may be applied from the left to the right in the unit of two pixels, four pixels, six pixels, and so on, every one second. Accordingly, the moving speed of the boundary between the first area and the second area can be determined.

The input unit 160 may receive a command to switch between a general screen mode and a demo screen mode in which general video signals and video signals of improved image quality coexist. The input unit 160 may be realized as a key input unit which is attached to one side of the display apparatus 100. Selecting a specific key of the input unit 160 allows switching between the general screen mode and the demo screen mode. The demo screen mode may include a general demo screen mode and a movable demo screen mode.

Also, the input unit 160 may receive a command to switch between the movable demo screen mode and the general demo screen mode. In the movable demo screen mode, the boundary between the first area and the second area is movable, and in the general demo screen mode, the first area and the second area are displayed in double windows occupying the same area. That is, if a command to switch to the general demo screen mode is input through the input unit 160 while the boundary between the first area and the second area is moving in a specific pattern, the screen is displayed in the general demo screen mode of double windows.

Hereinafter, how the boundary between the first area and the second area moves in a specific pattern will be described with reference to the drawings in detail.

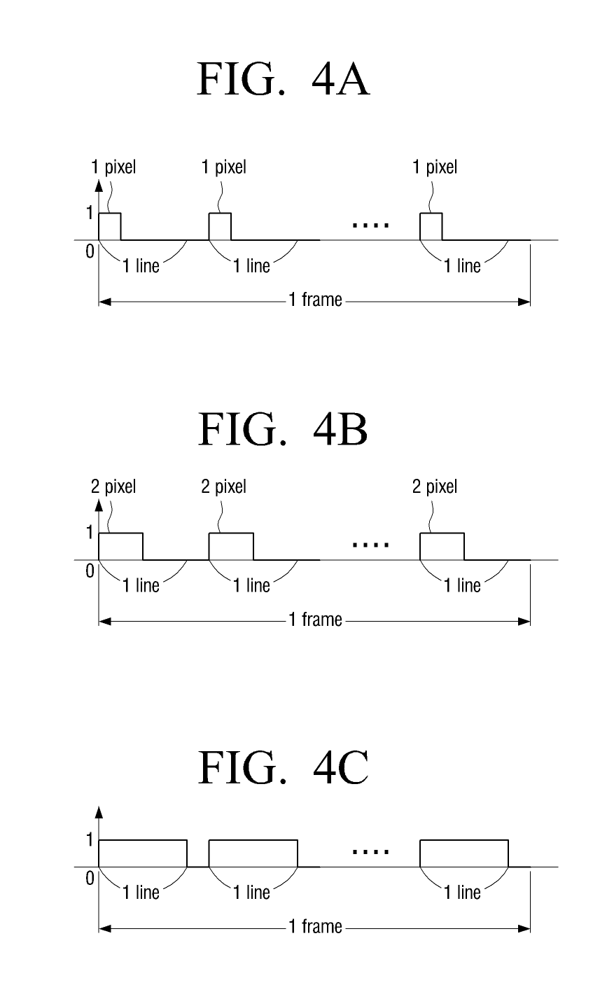

FIGS. 4A to 4C are views illustrating an example of a display pattern in which the area of improved image quality moves horizontally. FIGS. 4A to 4C illustrate an example of a pattern in which the boundary moves from the left to the right on the display screen.

FIGS. 4A illustrates a single frame which consists of a plurality of lines. It can be seen that image quality improvement is applied to the first pixel on the left of each line. Accordingly, a vertical boundary is formed on the leftmost side on the display screen.

It can be seen from FIG. 4B that image quality improvement is applied to the first and the second pixels on the left of each line. Accordingly, the image quality improvement is applied to the first and the second pixels of each line but is not applied to the third pixel of each line. That is, a boundary is formed between the second pixel and the third pixel of each line of the display screen.

FIG. 4C illustrates an example of data enable signal. A data enable signal may be applied to each of the plurality of lines on the entire screen. Accordingly, the process enable signal of the signal generation unit 140 is applied to a part of the entire display screen to which the data enable signals are applied (for example, to first line, first pixel, or second pixel).

As shown in FIGS. 4A and 4B, such operations are performed in sequence at predetermined time intervals such that the boundary between the first area to which image quality improvement is not applied and the second area to which image quality improvement is applied moves from the left to the right. In the case that the boundary moves from the right to the left unlike FIGS. 4A to 4C, the same method is adopted.

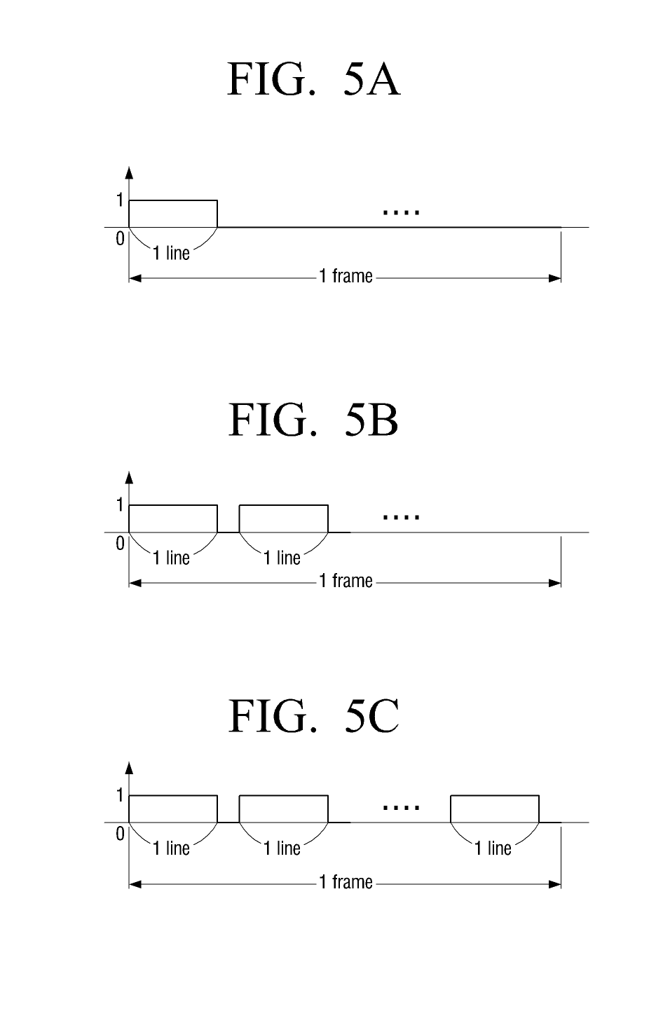

FIGS. 5A to 5C are views illustrating an example of a display pattern in which the area of improved image quality moves vertically. FIGS. 5A to 5C illustrate an example of a pattern in which the boundary moves from the top to the bottom.

FIG. 5A illustrates a single frame in which image quality improvement is applied to all pixels of the uppermost line of the entire display screen. FIG. 5B illustrates a single frame in which image quality improvement is applied to all pixels of the first upper line and the second upper line. Like FIG. 4C, FIG. 5C illustrates the data enable signal being applied to the entire display screen. Accordingly, the boundary between the first area and the second area moves from a line between the first upper line and the second upper line to a line between the second upper line and the third upper line at predetermined time intervals. In the case that the boundary moves from the bottom to the top unlike FIGS. 5A and 5B, the same method is adopted

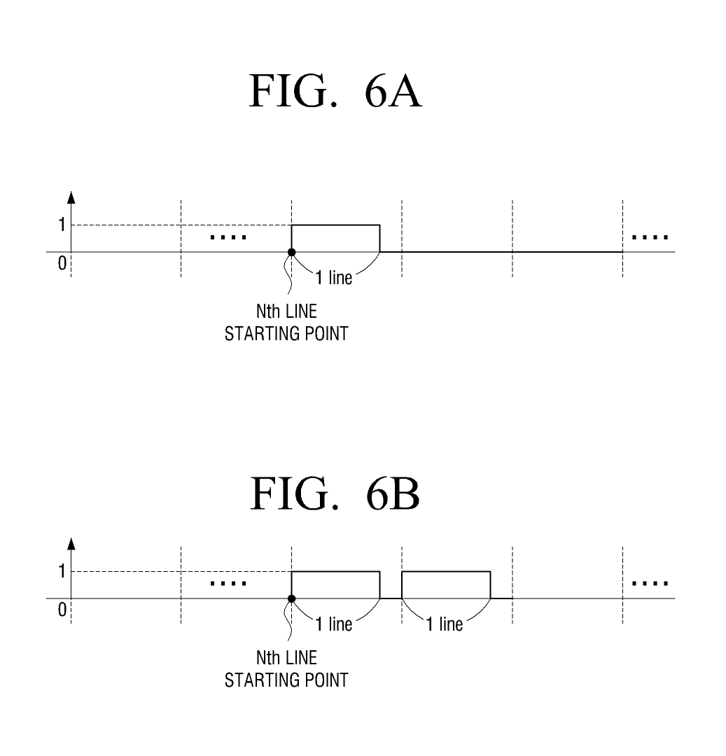

FIGS. 6A and 6B are views illustrating another example of a display pattern in which the area of improved image quality moves vertically. FIGS. 6A and 6B illustrate another example of a pattern in which the boundary moves from the top to the bottom on the display screen. Referring to FIGS. 6A and 6B, however, a starting point of a specific pattern is a specific line between the uppermost line and the lowermost line, that is, an nth line, rather than the uppermost line or the lowermost line of the display screen.

As shown in FIGS. 6A and 6B, if a process enable signal is applied to the nth line (n is integer greater than 0) at first, a boundary moves from a line between the nth line and the n+1th line to a line between the n+1th line and the n+2th line. Of course, the moving speed or moving direction of the boundary may be set through the UI unit 150.

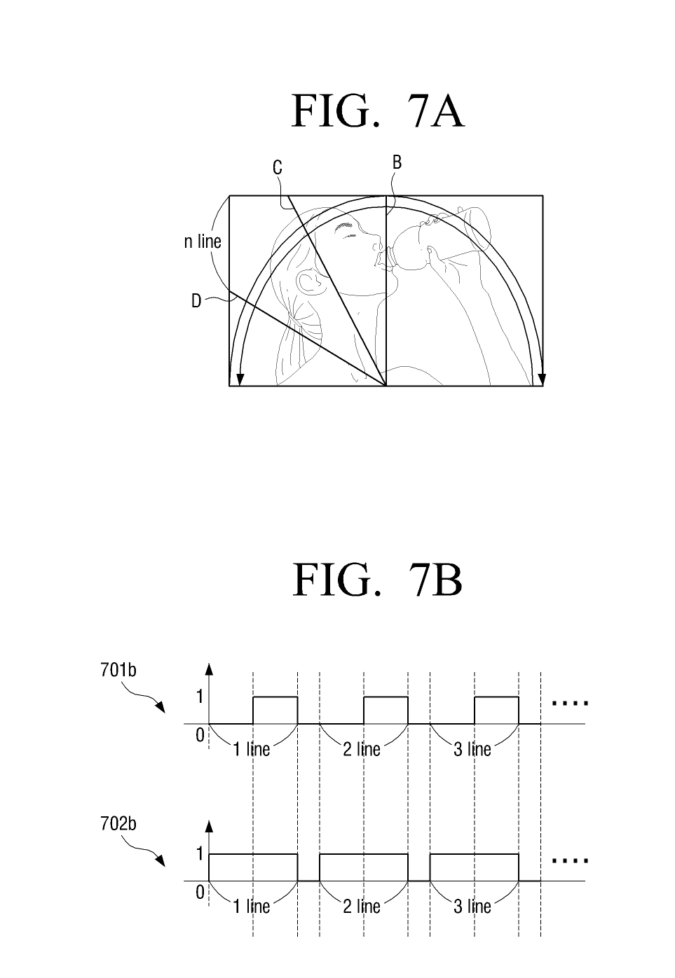

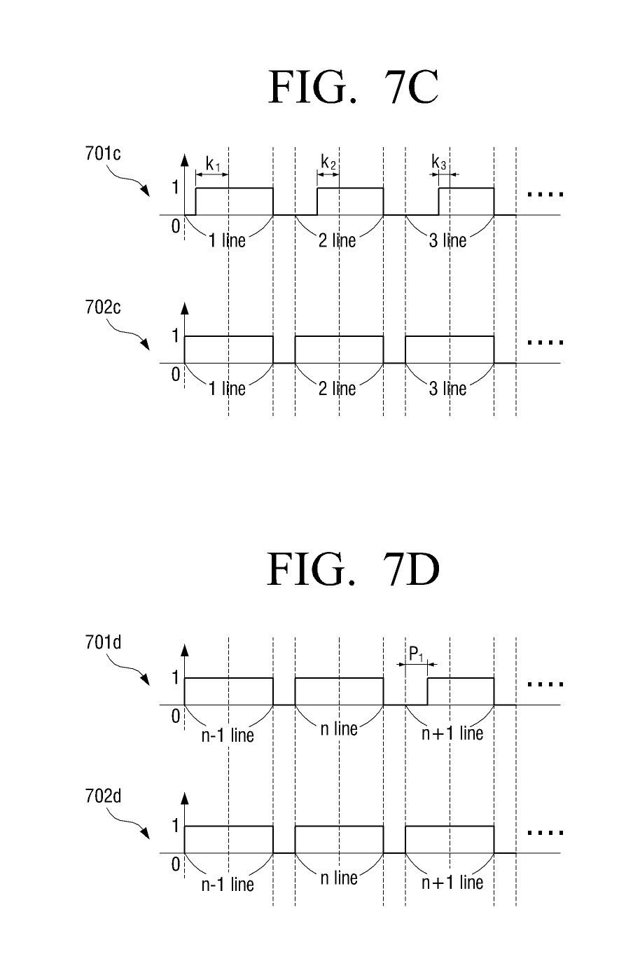

FIGS. 7A to 7D are views illustrating various display patterns of the display apparatus according to an exemplary embodiment of the present invention.

FIG. 7A illustrates a display pattern in which a reference point is located at an intermediate point of the lowermost line of the display screen and the image quality improvement is applied as the boundary moves like a windshield wiper. The display pattern according to the sequence of parts B, C, and D will be described with reference to FIG. 7A. The parts B, C, and D shown in FIG. 7 each represents a specific moment in the movable demo screen mode while the boundary is moving.

At the moment B shown in FIG. 7A, the second area to which the image quality improvement is applied (the right area of the display screen) and the first area to which the image quality improvement is not applied (the left area) are divided equally. In this case, if a data enable signal is applied to each line of the entire display screen as shown in the display pattern 702b of FIG. 7B, the image quality improvement is applied to only the right area of each line as shown in the display pattern 701b of FIG. 7B.

Next, at the moment C, the second area to which image quality improvement is applied occupies more spaces than the first area to which image quality improvement is not applied. In this case, the length of each line which is occupied by the second area on the left of the reference point becomes smaller from the top to the bottom of the single frame. That is, as shown in the display pattern 701c of FIG. 7C, the relationship such as k₁>k₁>k₂ . . . may be established from the top to the bottom of the single frame.

At the moment D, the second area to which image quality improvement is applied occupies most of the single frame. In this case, it can be seen from FIG. 7A that he second area to which image quality improvement is applied exists only from the first line to the nth line. The first area to which image quality improvement is not applied appears from the n+1th line (see the display pattern 701d of FIG. 7D) and then the length P₁ of the first area to which the image quality improvement is not applied becomes longer.

In the method described above, the display pattern in which the image quality improvement is applied as the boundary moves like a windshield wiper is provided.

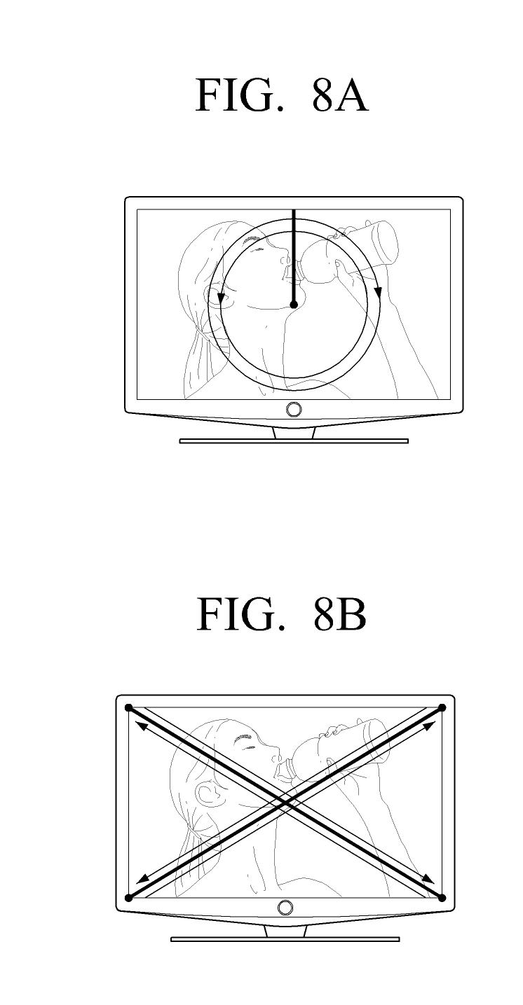

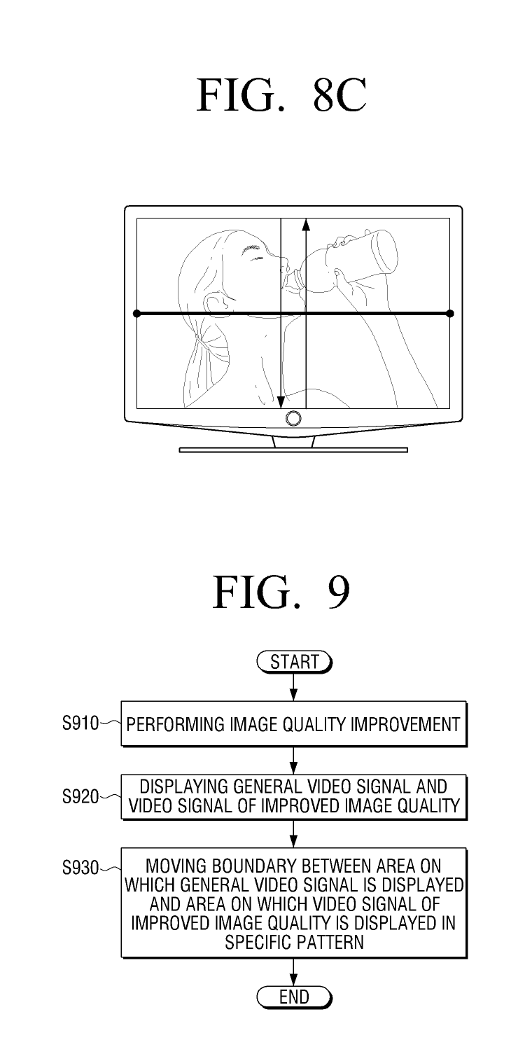

FIGS. 8A to 8C are views illustrating various display patterns of the display apparatus consistent with another exemplary embodiment of the present invention. Referring to FIG. 8A, a reference point is located in the center of the display screen and image quality improvement is applied in a circle pattern as the boundary moves.

In FIG. 8B, a reference point is located at each corner of the display screen and image quality improvement is applied in an oblique direction as the boundary moves. That is, FIG. 8B illustrates an example of a pattern in which the boundary moves from a specific point to an opposite point.

In FIG. 8C, a reference point is located in the middle of the display screen and the image quality improvement is applied in a vertical direction.

The display patterns shown in FIGS. 8A to 8C may adopt a method similar to that of FIGS. 7A to 7C and thus detailed description is omitted.

In the above, the lines on the left of the display screen are numbered from the leftmost line, such as the first line, the second line, and so on, and the lines on the right of the display screen are numbered from the rightmost line. Also, the lines on the upper portion of the display screen are numbered from the uppermost line such as the first line, the second line, and so on, and the lines on the lower portion of the display screen are numbered from the lowermost line.

FIG. 9 is a flowchart illustrating a displaying method of a display apparatus consistent with an exemplary embodiment of the present invention. Referring to FIG. 9, a displaying method performs image quality improvement using the image quality improvement unit 110 (S910), and displays general video signals and video signals of improved image quality on the display unit 120 (S920).

After that, the controller 130 moves a boundary between the area on which the general video signals are displayed and the area on which the video signals of improved image quality are displayed in a specific pattern (S930).

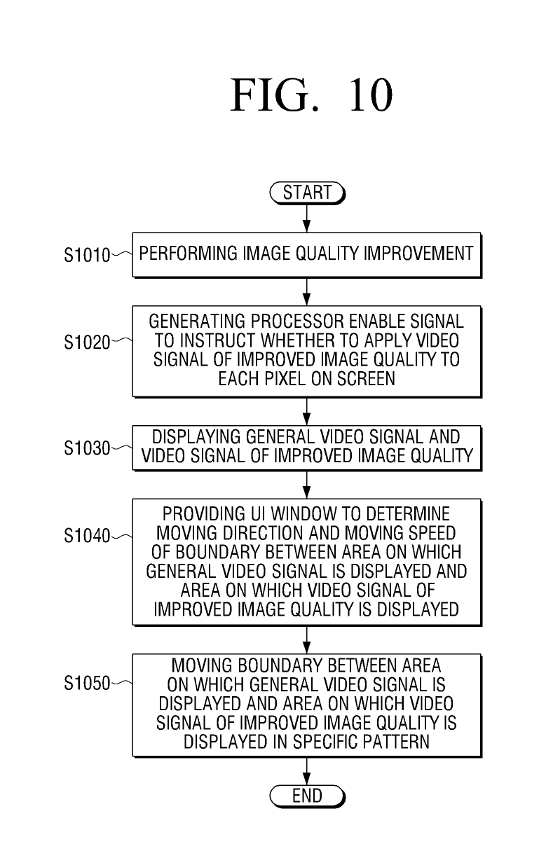

FIG. 10 is a detailed flowchart of FIG. 9. Referring to FIG. 10, the displaying method performs image quality improvement using the image quality improvement unit 110 (S1010) and generates a process enable signal to instruct whether to apply a video signal of improved image quality to each pixel on the screen using the signal generator 140.

Next, the display unit 120 displays general video signals and video signals of improved image quality (S1030).

In this case, the UI unit 150 may display a UI window through which a moving direction and a moving speed of the boundary between the area on which the general video signals are displayed and the area on which the video signals of improved image quality are displayed is set (S1040).

Next, the controller 130 moves the boundary between the area on which the video signals are displayed and the area on which the video signals of improved image quality are displayed in a specific pattern (S1050).

The foregoing exemplary embodiments and aspects are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus comprising:
an image quality improvement unit which performs image quality improvement on general video signals to generate improved video signals;
a display unit which displays the general video signals and improved video signals; and
a control unit which controls the display unit to move a boundary between a first area on which the general video signals are displayed and a second area on which the improved video signals are displayed, in a specific pattern.

2. The display apparatus as claimed in claim 1, further comprising a signal generation unit which generates a signal to instruct whether to apply the improved video signal to each pixel on a screen, and transmits the signal to the display unit.

3. The display apparatus as claimed in claim 1, wherein the boundary moves periodically according to the specific pattern.

4. The display apparatus as claimed in claim 1, wherein, if the boundary moves in one direction according to the specific pattern, the boundary moves again in a direction opposite to the one direction.

5. The display apparatus as claimed in claim 1, further comprising a user interface (UI) unit which provides a UI window to determine a moving direction of the boundary or a moving speed of the boundary.

6. The display apparatus as claimed in claim 1, wherein the specific pattern is at least one of a pattern in which the boundary moves in a horizontal direction on a display screen of the display unit, a pattern in which the boundary moves in a vertical direction on the display screen, a pattern in which the boundary moves from a specific point on the display screen to a point opposite the specific point, and a pattern in which the boundary rotates from a specific point on the display screen with a predetermined angle.

7. The display apparatus as claimed in claim 1, further comprising an input unit which receives a first command to switch between a general screen mode and a demo screen mode in which the general video signals and the improved video signals are displayed at a same time.

8. The display apparatus as claimed in claim 7, wherein the input unit receives a second command to switch between a movable demo screen mode in which the first area and the second area are displayed with the boundary and a still demo screen mode in which the first area and the second area are fixedly displayed.

9. A displaying method of a display apparatus, the method comprising:
performing image quality improvement on general video signals to generate improved video signals;
displaying the general video signals and the improved video signals on a display unit; and
moving a boundary between a first area on which the general video signals are displayed and a second area on which the improved video signals are displayed, in a specific pattern.

10. The displaying method as claimed in claim 9, further comprising generating a signal to instruct whether to apply the improved video signal to each pixel on a screen, and transmitting the signal to the display unit.

11. The displaying method as claimed in claim 9, wherein the boundary moves periodically according to the specific pattern.

12. The displaying method as claimed in claim 9, wherein, if the boundary moves in one direction according to the specific pattern, the boundary moves again in a direction opposite to the one direction.

13. The displaying method as claimed in claim 9, further comprising providing a user interface (UI) window to determine a moving direction of the boundary or a moving speed of the boundary.

14. The displaying method as claimed in claim 9, wherein the specific pattern is at least one of a pattern in which the boundary moves in a horizontal direction on a display screen of the display unit, a pattern in which the boundary moves in a vertical direction on the display screen, a pattern in which the boundary moves from a specific point on the display screen to a point opposite the specific point, and a pattern in which the boundary rotates from a specific point on the display screen with a predetermined angle.

15. The displaying method as claimed in claim 9, further comprising receiving a first command to switch between a general screen mode and a demo screen mode in which the general video signals and the improved video signals are displayed at a same time.

16. The displaying method as claimed in claim 15, wherein the receiving operation receives a second command to switch between a movable demo screen mode in which the first area and the second area are displayed with the boundary and a still demo screen mode in which the first area and the second area are fixedly displayed.

17. A display method comprising:
processing at least a portion of a first video signal of a video image to generate a second video signal of the video image;
simultaneously displaying the first video signal and the second video signal on a screen; and
reducing a size of the first portion of the video image and enlarging a size of the second portion of the video image, wherein an amount of the reducing inversely corresponds to an amount of the enlarging,
wherein the first video signal displays a first portion of the video image and the second video signal displays a second portion of the video image, and
wherein the first and the second portions of the video image are non-overlapping.
